(19) United States
(12) Patent Application Publication
(10) Pub. No.: US 2026/0030713 A1
(43) Pub. Date: Jan. 29, 2026

(54) SYSTEMS, METHODS, AND MEDIA FOR IMPLEMENTING TENSOR-TRAINS IN GRAPHICS PROCESSING UNIT TENSOR CORES

(71) Applicant: The Trustees of Columbia University in the City of New York, New York, NY (US)

(72) Inventors: Xiao-Yang Liu, New York, NY (US); Xiaodong Wang, Ramsey, NJ (US)

(21) Appl. No.: 19/279,957

(22) Filed: Jul. 24, 2025

Related U.S. Application Data
(60) Provisional application No. 63/675,144, filed on Jul. 24, 2024.

(51) Int. Cl. G06T 1/20; G06N 3/08

(52) U.S. Cl. CPC G06T 1/20; G06N 3/08

(57) ABSTRACT

Mechanisms including: partitioning a first matrix into first blocks along a column dimension and partitioning a second matrix into second blocks along a row dimension; loading a first block of the first blocks and a second block of the second blocks into a first GPU tensor core; performing a multiplication of the first block and the second block to produce a first product; loading a third block of the first blocks and a fourth block of the second blocks into a second GPU tensor core; performing a multiplication of the third block and the fourth block to produce a second product; and summing at least the first product and the second product to produce a first sum.

### CROSS-REFERENCE TO RELATED APPLICATION

This application claims the benefit of U.S. Provisional Patent Application No. 63/675,144, filed Jul. 24, 2024, which is hereby incorporated by reference herein in its entirety.

### BACKGROUND

Real world high-dimensional data is often represented as tensors, such as big data, Internet of Things indoor localization, genetic analysis, and quantum machine learning. These high-dimensional tensors may consume extensive resources as the time complexity and memory footprint grow exponentially with the order of the data tensor.

Tensor decomposition algorithms represent a high-dimensional data array as a contracted network of small factor tensors, e.g., tensor-train (TT) structure. As shown in FIG. 2, a d-th order tensor in [symbol] ^{n× . . . ×n} can be modeled as d small third-order tensors connected in a train structure, where [symbol] (n^{d}) data entries are compactly represented by [symbol] (dnr²) parameters.

Tensor-train structures have been widely used in many applications, such as big data analysis for Cyber-Physical-Social system (CPSS), neural network compression, and quantum machine learning. However, since the time complexity and memory consumption exponentially increase with the order of tensors, tensor-train decomposition algorithms are compute-intensive, which hinders their applications.

Many existing works focused on improving the performance of tensor decomposition algorithms. However, they did not sufficiently utilize graphics processing unit (GPU) tensor cores designed for tensor operations. More efficient and scalable primitives are required.

Accordingly, new mechanisms for implementing tensor-trains in graphics processing unit tensor cores are desirable.

### SUMMARY

In accordance with some embodiments, mechanisms, including systems, methods, and media for implementing tensor-trains in graphics processing unit tensor cores are provided.

In some embodiments, systems for implementing tensor-trains are provided, the systems comprising: a memory; at least one hardware processor collectively configured to perform at least one of: (A.1) partitioning a first matrix into a first plurality of blocks along a column dimension and partitioning a second matrix into a second plurality of blocks along a row dimension; and (B.1) partitioning a third matrix into a third plurality of blocks along a column dimension; and a first graphics processing unit (GPU) tensor core configured to perform at least one of: (A.2) loading a first block of the first plurality of blocks and a second block of the second plurality of blocks into the first GPU tensor core; and (A.3) performing a multiplication of the first block and the second block to produce a first product; and (B.2) loading a fourth matrix and a fifth block of the third plurality of blocks into a third graphics processing unit tensor core; and (B.3) performing a multiplication of the fourth matrix and the fifth block to produce a third product; a second GPU tensor core configured to: (A.4) load a third block of the first plurality of blocks and a fourth block of the second plurality of blocks into the second GPU tensor core; (A.5) perform a multiplication of the third block and the fourth block to produce a second product; and (A.6) summing at least the first product and the second product to produce a first sum. In some of these embodiments, the at least one of the hardware processor also performs at least one of: prior to partitioning the first matrix and the second matrix, reducing a precision of the first matrix and the second matrix; and prior to partitioning the third matrix, reducing a precision of the third matrix and the fourth matrix. In some of these embodiments, the first GPU tensor core also: performs a QR factorization of the first sum to produce a first orthogonal matrix; performs a multiplication of the first orthogonal matrix and a transposition of the first orthogonal matrix to produce a fourth product; performs an eigenvalue decomposition of the fourth product to obtain first eigenvectors; reverse the order of the first eigenvectors to produce second eigenvectors; performs a multiplication of the first orthogonal matrix and the second eigenvectors to produce a fifth product; performs a multiplication of a transposition of the second eigenvectors and the first orthogonal matrix to produce a sixth product; and folds the fifth product and the sixth product. In some of these embodiments, the at least one hardware processor also matricizes a first tensor to produce the first matrix and transfers the first matrix to the first GPU tensor core; and the first GPU tensor core, at least partially concurrently with the transferring of the first matrix to the first GPU tensor core, generates the second matrix. In some of these embodiments, the first GPU tensor core also trains a tensor-train tensor layer of a neural network. In some of these embodiments, the first GPU tensor core also performs a parallel Density Matrix Renormalization Group (DMRG) algorithm.

In some embodiments, methods of implementing tensor-trains are provided, the methods comprising: performing at least one of: partitioning a first matrix into a first plurality of blocks along a column dimension and partitioning a second matrix into a second plurality of blocks along a row dimension; loading a first block of the first plurality of blocks and a second block of the second plurality of blocks into a first graphics processing unit (GPU) tensor core; performing a multiplication of the first block and the second block to produce a first product; loading a third block of the first plurality of blocks and a fourth block of the second plurality of blocks into a second GPU tensor core; performing a multiplication of the third block and the fourth block to produce a second product; and summing at least the first product and the second product to produce a first sum; and partitioning a third matrix into a third plurality of blocks along a column dimension; loading a fourth matrix and a fifth block of the third plurality of blocks into a third graphics processing unit tensor core; and performing a multiplication of the fourth matrix and the fifth block to produce a third product. In some of these embodiments, the method further comprises: prior to partitioning the first matrix and the second matrix, reducing a precision of the first matrix and the second matrix; and prior to partitioning the third matrix, reducing a precision of the third matrix and the fourth matrix. In some of these embodiments, the method further comprises: performing a QR factorization of the first sum to produce a first orthogonal matrix; performing a multiplication of the first orthogonal matrix and a transposition of the first orthogonal matrix to produce a fourth product; performing an eigenvalue decomposition of the fourth product to obtain first eigenvectors; reversing the order of the first eigenvectors to produce second eigenvectors; performing a multiplication of the first orthogonal matrix and the second eigenvectors to produce a fifth product; performing a multiplication of a transposition of the second eigenvectors and the first orthogonal matrix to produce a sixth product; and folding the fifth product and the sixth product. In some of these embodiments, the method further comprises: matricizing a first tensor to produce the first matrix; and at least partially concurrently, transferring the first matrix to the first GPU tensor core and generating the second matrix. In some of these embodiments, the method further comprises training a tensor-train tensor layer of a neural network. In some of these embodiments, the method further comprises performing a parallel Density Matrix Renormalization Group (DMRG) algorithm.

In some embodiments, non-transitory computer-readable media containing computer executable instructions that, when collectively executed by at least one processor, a first graphics processing unit (GPU) tensor core, and a second GPU tensor core, cause the at least one processor, the first GPU tensor core, and the second GPU tensor core to collectively perform a method of implementing tensor-trains, the method comprising: partitioning a first matrix into a first plurality of blocks along a column dimension and partitioning a second matrix into a second plurality of blocks along a row dimension; loading a first block of the first plurality of blocks and a second block of the second plurality of blocks into a first GPU tensor core; performing a multiplication of the first block and the second block to produce a first product; loading a third block of the first plurality of blocks and a fourth block of the second plurality of blocks into a second GPU tensor core; performing a multiplication of the third block and the fourth block to produce a second product; and summing at least the first product and the second product to produce a first sum; partitioning a third matrix into a third plurality of blocks along a column dimension; loading a fourth matrix and a fifth block of the third plurality of blocks into a third graphics processing unit tensor core; and performing a multiplication of the fourth matrix and the fifth block to produce a third product. In some of these embodiments, the method further comprises at least one of: prior to partitioning the first matrix and the second matrix, reducing a precision of the first matrix and the second matrix; and prior to partitioning the third matrix, reducing a precision of the third matrix and the fourth matrix. In some of these embodiments, the method further comprises: performing a QR factorization of the first sum to produce a first orthogonal matrix; performing a multiplication of the first orthogonal matrix and a transposition of the first orthogonal matrix to produce a fourth product; performing an eigenvalue decomposition of the fourth product to obtain first eigenvectors; reversing the order of the first eigenvectors to produce second eigenvectors; performing a multiplication of the first orthogonal matrix and the second eigenvectors to produce a fifth product; performing a multiplication of a transposition of the second eigenvectors and the first orthogonal matrix to produce a sixth product; and folding the fifth product and the sixth product. In some of these embodiments, the method further comprises: matricizing a first tensor to produce the first matrix; and at least partially concurrently, transferring the first matrix to the first GPU tensor core and generating the second matrix. In some of these embodiments, the method further comprises training a tensor-train tensor layer of a neural network. In some of these embodiments, the method further comprises performing a parallel Density Matrix Renormalization Group (DMRG) algorithm.

### BRIEF DESCRIPTION OF THE DRAWINGS

FIG. 1 illustrates an example of an overall software and hardware stack for implementing tensor-train primitives in accordance with some embodiments.

FIG. 2 illustrates that a d-th order tensor in [symbol] ^{n× . . . ×n} can be modeled as d small third-order tensors connected in a train structure in accordance with some embodiments.

FIG. 3 illustrates and example of a tensor layout in memory in accordance with some embodiments.

FIG. 4 illustrates fat-and-tall and small-and-fat matrix multiplications using GPU tensor cores in accordance with some embodiments.

FIG. 5 illustrates an overlapping of data transfer and tensor computation in accordance with some embodiments.

FIG. 6 illustrates schedules of high-order tensor decomposition on multiple GPUs in accordance with some embodiments.

FIG. 7 illustrates an example of a forward pass of a tensor-train layer in accordance with some embodiments.

FIG. 8 illustrates parameters update processes in one epoch with N nodes in accordance with some embodiments.

FIGS. 9A-9C are an illustration of the operation of a density matrix renormalization group (DMRG) algorithm in accordance with some embodiments.

FIG. 10 is an algorithm for tensor-train tensor decomposition using GPU tensor cores in accordance with some embodiments.

FIG. 11 is an example block diagram of hardware that can be used in accordance with some embodiments.

### DETAILED DESCRIPTION

In accordance with some embodiments, mechanisms, including systems, methods, and media for implementing tensor-trains in graphics processing unit tensor cores are provided.

In accordance with some embodiments, tensor-train primitives that use GPU tensor cores are provided. More particularly, in some embodiments, tensor-train primitives that perform tensor contraction, singular value decomposition, and data transfer and computing using GPU tensor cores are provided. In some embodiments, these primitives can be used to accelerate tensor-train decomposition algorithms for big data analysis. In some embodiments, a shard mode for high-order tensor computations on multiple GPUs is also provided. In some embodiments, the described primitives can also be used to accelerate tensor-train layers for compressing deep neural networks. In some embodiments, the described primitives can further be used to accelerate a quantum machine learning algorithm called Density Matrix Renormalization Group (DMRG) algorithm.

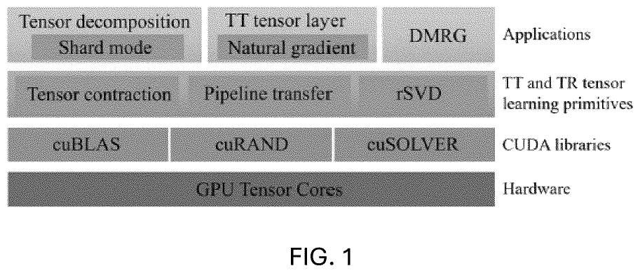

In accordance with some embodiments, a tensor-train primitives can be implemented on any suitable software and hardware stack. FIG. 1 illustrates an example of a software and hardware stack that can be used to implement tensor-train primitives, in some embodiments.

As shown, at a bottom layer, the stack can include one or more hardware GPU tensor cores. Any suitable GPU tensor cores can be included in the bottom layer in some embodiments and any other suitable hardware (such a central processing unit, memory, one or more buses, one or more interfaces, etc.) can be included in the bottom layer, in some embodiments.

As also shown in FIG. 1, the next layer up from the bottom can include any suitable libraries, in some embodiments. For example, as shown in FIG. 1, the libraries can include CUDA libraries, such as the CUBLAS library, the CURAND library, and the CUSOL VER library, which are available from NVIDIA CORPORATION of Santa Clara, California, in some embodiments.

As further shown in FIG. 1, at a next layer up, the stack can include one or more tensor primitives. Any suitable primitives can be included, such as a tensor contraction primitive, a pipeline transfer primitive, and a randomized singular value decomposition (rSVD) primitive, can be used in some embodiments. Examples of these primitives, in accordance with some embodiments, are provided below.

At a top layer, the stack can include one or more applications, in some embodiments. Any suitable applications can be included in some embodiments. For example, in some embodiments, applications that implement tensor decomposition (which may include a shard mode, in some embodiments), a tensor-train tensor layer (which may use a natural gradient, in some embodiments), and/or a Density Matrix Renormalization Group (DMRG) algorithm, can be included in some embodiments.

### Example Notations for Matrix and Tensor Operations

In accordance with some embodiments, the following notation is used herein. Let * and ∘ denote the Hadamard (element-wise) product and tensor contraction, respectively. A^{T} and A^{†} denote the transposition and pseudo-inverse of matrix A, respectively. A(:,j) denotes the j-th column of A∈ [symbol] ^{I×J} and A (:,j:k) denotes the j-th to the k-th columns. [symbol] (:,:,k)∈ [symbol] ⁿ^{₁}^{×n}^{₂}^{×1} denotes the k-th frontal slice of [symbol] ∈ [symbol] ⁿ^{₁}^{×n}^{₂}^{×n}^{₃}, k=1, . . . , n₃. Let fl₁₆(A) and fl₃₂(A) denote the 16-bit and 32-bit precision representation of A, respectively. Any other suitable notation can additionally or alternatively be used in some embodiments.

In some embodiments, various tensor operations involve unfolding or folding a tensor into a matrix. The mode-n matricization of [symbol] ∈ [symbol] ⁿ^{₁}^{×n}^{₂}^{×n}^{₃} is denoted as A₍ₙ₎ by organizing the mode-n tubes as columns, for n=1, 2, 3.

In some embodiments, given two third-order tensors A∈ [symbol] ⁿ^{₁}^{×n}^{₂}^{×n}^{₃} and [symbol] ∈ [symbol] ⁿ^{₃}^{×n}^{₄}^{×n}^{₅}, the tensor contraction results in a fourth-order tensor [symbol] = [symbol] ∘ [symbol] ∈ [symbol] ⁿ^{₁}^{×n}^{₂}^{×n}^{₄}^{×n}^{₅}.

### Tensor-Train Structures

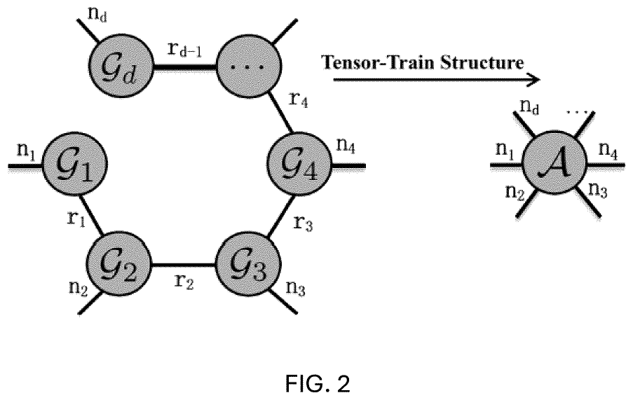

In some embodiments, a tensor-train (TT) structure is a special case of a tensor network that can be represented as a graphical model, as illustrated in FIG. 2. In some embodiments, a tensor-train structure uses tensor contractions to connect third-order core tensors [symbol] ₁∈ [symbol] ^{r}^{₀}^{×n}^{₁}^{×r}^{₁}, [symbol] ₂∈ [symbol] ^{r}^{₁}^{×n}^{₂}^{×r}^{₂}, and [symbol] ₃∈ [symbol] ^{r}^{₂}^{×n}^{₃}^{×r}^{₃} in a chain structure, which compactly represents tensor [symbol] ∈ [symbol] ⁿ^{₁}^{×n}^{₂}^{×n}^{₃} as:

$$𝒜 = {𝒢}_{1} ∘ {𝒢}_{2} ∘ {𝒢}_{3} . \qquad ( 1 )$$

In some embodiments, the tuple (r₀, r₁, r₂, r₃) is called tensor-train ranks (TT-ranks), where we have r₀=r₃=1.

In some embodiments, a third-order tensor-train tensor decomposition can be used to convert a third-order tensor with given TT-ranks (r₀, r₁, r₂, r₃) into a TT structure with three tensors.

### Efficient Memory Access

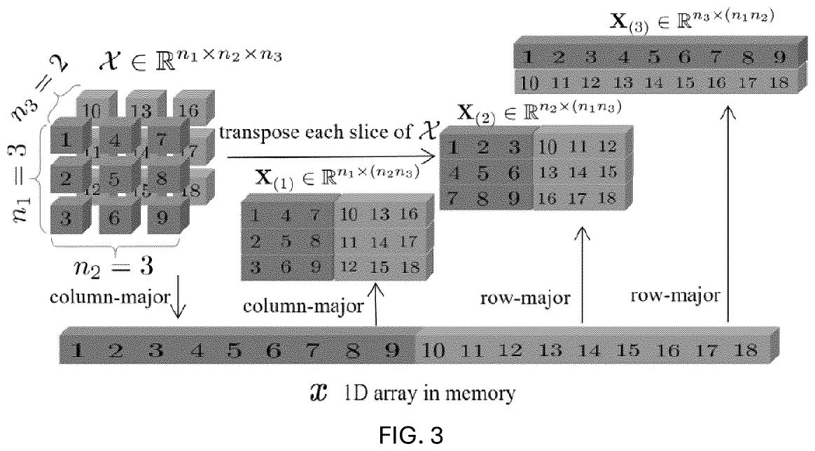

In some embodiments, in GPU memory, a column-major layout of a tensor is a one-dimensional array, which can be used to avoid explicit conversions between the tensor and matrices. As shown in FIGS. 3, X₍₁₎, X₍₂₎ and X₍₃₎ can be obtained by different strategies of memory organizations and access, in some embodiments.

FIG. 3 illustrates an example of a layout of a 3×3×2 tensor [symbol] in a vector x with three formats of matricizations, in accordance with some embodiments. As shown, for example, in some embodiments: Mode-1 (X₍₁₎) matricization in column-major storage directly corresponds to the storage of the tensor; Mode-3 (X₍₃₎) matricization in row-major storage can be obtained directly by x; and Mode-2 (X₍₂₎) matricization in row-major storage can be obtained by x(1:9) and x(10:18).

### Tensor Contractions Using GPU Tensor Cores

In some embodiments, the computational complexity of tensor contraction grows exponentially with increasing the size of tensors. In some embodiments, there are two kinds of tensor contraction: C= [symbol] ∘B; and [symbol] =Q^{T}∘ [symbol] . In accordance with some embodiments, using efficient memory access, the layout of the mode-1 matrix matricization A₍₁₎ and tensor [symbol] in GPU memory can be the same as shown in FIG. 3. Thus, in accordance with some embodiments, tensor contractions C= [symbol] ∘B and [symbol] =Q^{T}∘ [symbol] can be performed directly through matrix multiplications C=A₍₁₎B and D₍₁₎=Q^{T}A₍₁₎, respectively.

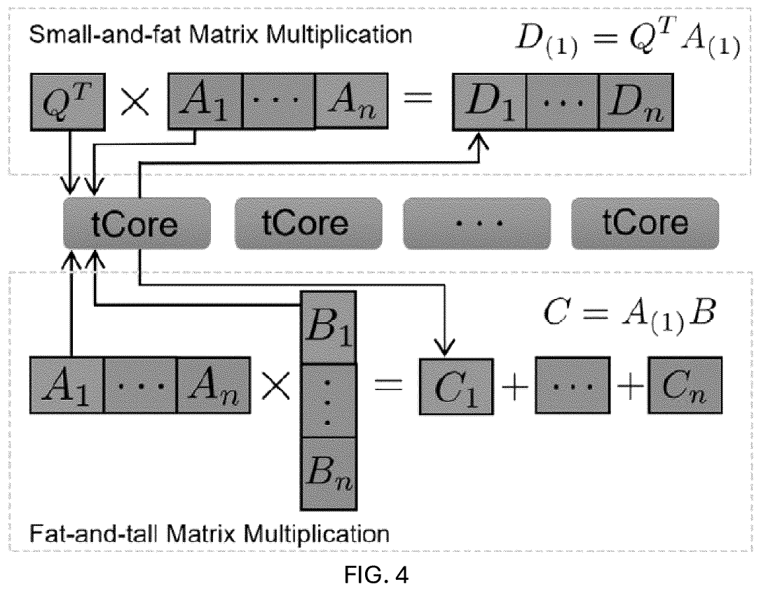

As shown in FIG. 3, in some embodiments, since matrix A₍₁₎∈ [symbol] ^{r}^{₀}ⁿ^{₁}^{×n}^{₂}ⁿ^{₃}^{r}^{₃} (shown in FIG. 3 as X₍₁₎) is obtained from tensor [symbol] ∈ [symbol] ^{r}^{₀}ⁿ^{₁}^{×n}^{₂}ⁿ^{₃}^{r}^{₃} (shown in FIG. 3 as [symbol] ), the number of columns n₂n₃r₃ for A₍₁₎ is much larger than the number of rows r₀n₁ for A₍₁₎. As such, A₍₁₎ can be referred to a fat matrix, in some embodiments. This is represented in FIG. 4 by a horizontal series of boxes A₁ . . . Aₙ.

As described above, B∈ [symbol] ⁿ^{₂}ⁿ^{₂}^{r}^{₃}^{×(r+p)}, where n₂n₃r₃»r+p, as such B can be referred to as a tall matrix, in some embodiment. This is represented in FIG. 4 by a vertical series of boxes B₁ . . . . Bₙ.

Matrix Q^{T}∈ [symbol] ^{(r+p)×r}^{₀}ⁿ^{₁}, where r+p«n₂n₃r₃ and r₀n₁«n₂n₃r₃, as such Q^{T} can be referred to as a small matrix, in some embodiments. This is represented in FIG. 4 by a single box Q^{T}.

Multiplying A₍₁₎ times B can be referred to as fat-and-tall matrix multiplication, in some embodiments, and multiplying Q^{T} times A₍₁₎ can be referred to as small-and-fat matrix multiplication, in some embodiments.

FIG. 4 illustrates performing fat-and-tall matrix multiplication and small-and-fat matrix multiplication in accordance with some embodiments. Each of these can be referred to as a batch multiplication, in some embodiments.

In some embodiments, to perform a fat-and-tall matrix multiplication of a fat matrix A₍₁₎∈ [symbol] ^{r}^{₀}ⁿ^{₁}^{×n}^{₂}ⁿ^{₃}^{r}^{₃} and a tall matrix B∈ [symbol] ⁿ^{₂}ⁿ^{₃}^{r}^{₃}^{×(r}^{₁}^{+p)} using GPU tensor cores, the following can be performed as shown in the bottom half of FIG. 4:
1. Reduce A₍₁₎ and B to 16-bit precision (or any other suitable precision that matches the computation mode on the GPU tensor cores).
2. Partition A₍₁₎ and B into n blocks along the column and row dimension, respectively.
3. For each i from 1 . . . n, load the i-th blocks, Aᵢ and Bᵢ, into the i-th tCore (tensor core) and calculate Cᵢ=AᵢBᵢ.
4. Add C₁, C₂, . . . , Cₙ to obtain C.

In some embodiments, to perform a small-and-fat matrix multiplication of a small matrix Q^{T}∈ [symbol] ^{(r+p)×r}^{₀}ⁿ^{₁} and a fat matrix A₍₁₎∈ [symbol] ^{r}^{₀}ⁿ^{₁}^{×n}^{₂}ⁿ^{₃}^{r}^{₃} with GPU tensor cores, the following can be performed as shown in the top half of FIG. 4:
1 Reduce Q^{T} and A₍₁₎ to 16-bit precision (or any other suitable precision that matches the computation mode on the GPU tensor cores).
2. Partition A into n blocks along the column dimension.
3. For each i from 1 . . . n, load Q^{T} and i-th block of A into the i-th tCore (tensor core) and calculate Dᵢ=Q^{T}Aᵢ.

By performing multiplication in the above-referenced ways, these mechanisms allow the operations to be conducted in parallel across multiple tensor cores, which makes the multiplications significantly faster.

### Tensor Randomized Singular Value Decomposition (SVD)

In accordance with some embodiments, eigenvalue decomposition-based tensor randomized SVDs (rSVDs) for memory compression are provided. In some embodiments, the tensor rSVDs convert a low-rank tensor into two tensors of a given rank r. In some embodiments, efficient memory access by column-major storage of tensors in GPU memory can be used to reduce memory footprint as shown in FIG. 3.

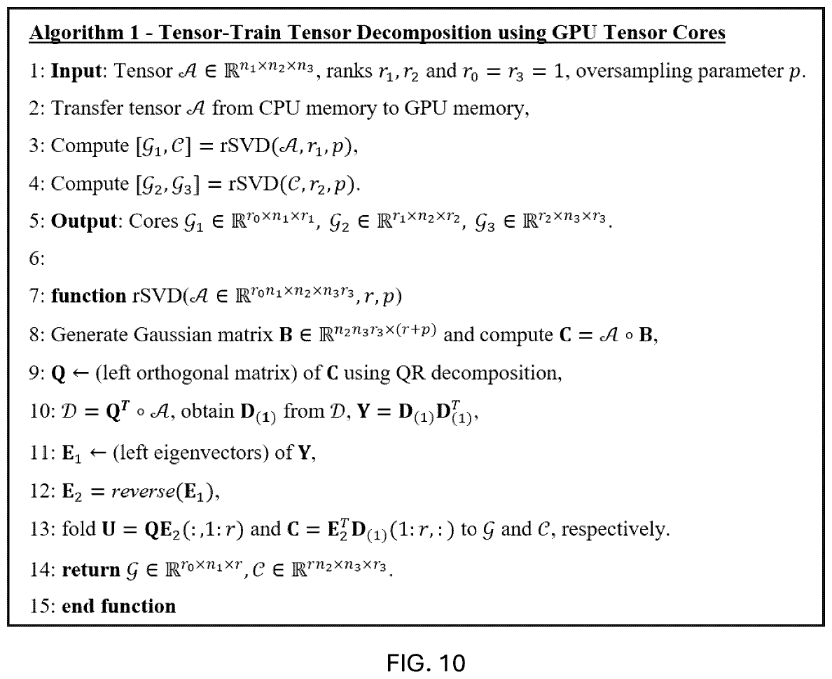

Turning to Algorithm 1 of FIG. 10, the operation of an example of a tensor rSVD in accordance with some embodiments is shown. As illustrated, for a tensor [symbol] ∈ [symbol] ^{r}^{₀}ⁿ^{₁}^{×n}^{₂}ⁿ^{₃}^{r}^{₃} rank r, and an oversampling parameter p, a tensor rSVD can perform the following steps:
1. Generate a random Gaussian matrix B∈ [symbol] ⁿ^{₂}ⁿ^{₃}^{r}^{₃}^{×(r+p)} and compute a tensor contraction C= [symbol] ·B as shown at line 8 of Algorithm 1.
2. Perform QR factorization of C to obtain orthogonal matrix Q∈ [symbol] ^{r}^{₀}ⁿ^{₁}^{×(r+p)} as shown at line 9 of Algorithm 1.
3. Compute a tensor contraction [symbol] =Q^{T}∘ [symbol] , obtain matrix D₍₁₎∈ [symbol] ^{(r+p)×n}^{₂}ⁿ^{₃}^{r}^{₃} from tensor [symbol] according to efficient memory access, and compute a fat-and-tall matrix multiplication

$$Y = {D}_{( 1 )} {D}_{( 1 )}^{T}$$

as shown at line 10 of Algorithm 1.
4. Perform an eigenvalue decomposition of Y to obtain eigenvectors E₁∈ [symbol] ^{(r+p)×(r+p)} as shown at line 11 of Algorithm 1.
5. Reverse the order of the column vectors of E₁ to obtain E₂ as shown at line 12 of Algorithm 1, where E₂(:,i)=E₁(:,(r+p)−i+1), i=1, . . . , r+p.
6. As shown at line 13 of Algorithm 1, compute U=QE₂(r₀n₁, 1:r)∈ [symbol] ^{r}^{₀}ⁿ^{₁}^{r} and a small-and-fat matrix multiplication

$$C = {E}_{2}^{T} {D}_{( 1 )} ( 1 : {r}_{1} , {n}_{2} {n}_{3} ) ∈ {ℝ}^{r \times {n}_{2} {n}_{3} {r}_{3}} ,$$

and fold U to [symbol] ∈ [symbol] ^{r}^{₀}^{×n}^{₁}^{×r}^{₁} and C to [symbol] ∈ [symbol] ^{r}^{₁}^{×n}^{₁}^{×n}^{₂}.

In some embodiments, the value of oversampling parameter p can be chosen from 0 to r, where r is the tensor rank. In some embodiments, when implement with GPU tensor cores having a 4×4×4 tensor operation pattern, setting p to 8 can lead to better performance of the above-described tensor rSVD. In some embodiments, the tensor rSVD described herein reduces the computation and memory footprint, which accelerates calculation and supports larger tensor size with limited GPU memory.

### Pipeline Data Transfer and Computing

In some embodiments, line 2 of Algorithm 1 of FIG. 10 transfers a tensor's data from CPU memory to GPU memory. The data volume of a tensor increases rapidly with an increase in the dimension and order of the tensor, in some embodiments. Because of the low bandwidth (e.g., 64 GB/s) of PCI-Express bus which are usually used to connect CPUs and GPUs, a bottleneck may occur on the data transfer between CPUs and GPUs, resulting in degraded performance.

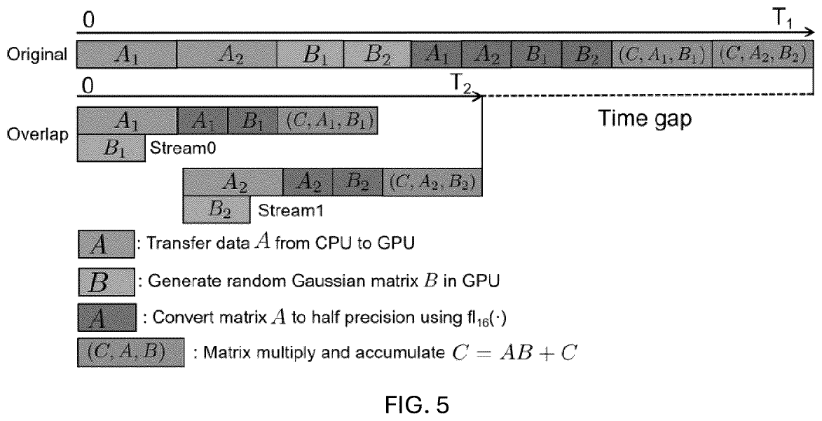

In accordance with some embodiments, to overcover this problem, a pipeline that takes advantage of the parallelism of GPU transmission and shard mode computation can be used. As shown in FIG. 5, the data transfer in line 2 of Algorithm 1 of FIG. 10 can be overlapped in time with the matrix multiplication using GPU tensor cores in lines 3-4 of Algorithm 1 of FIG. 10. In adjacent streams, the computation result C of the previous stream can be used by the next stream, in some embodiments. Is some embodiments, this can be performed as follows:
1. In stream 0 of FIG. 5, matricize [symbol] to A₍₁₎∈ [symbol] ⁿ^{₁}^{×n}^{₃}^{×n}^{₃} and partition A₍₁₎ into two blocks, A₁ and A₂, along the column dimension using efficient memory access as described above.
2. In stream 0, transfer A₁ from CPU to GPU and generate Gaussian matrix B₁∈

$${ℝ}^{\frac{{n}_{2} {n}_{3}}{2}} \times ( {r}_{1} + p )$$

on GPU at the same time.
3. In stream 0, reduce the precision of A₁ and B₁, and compute C=A₁B₁∈ [symbol] ⁿ^{₁}^{×(r}^{₁}^{+p)} using a batched fat-and-tall matrix multiplication as described above.
4. In stream 1, after stream 0 finishes transferring A₁ and B₁, transfer A₂ from CPU and GPU and generate Gaussian matrix B₂ on GPU at the same time.
5. In stream 1, reduce the precision of A₂ and B₂ and compute C=A₂B₂+C using a batched fat-and-tall matrix multiplication as described above.

The above pipeline scheme overlaps transmission and computation, which reduces the time of generating the Gaussian matrix and converting precision, reducing total time, in some embodiments. For example, in some embodiments, both the data transfer and matrix multiplication consume around 2×cost in terms of time steps compared with the precision reduction. Using this pipeline technique, in some embodiments, the required time steps can be reduced from 10 to 5, achieving a theoretical of 2×speedup in processing.

### High Order Tensor-Train (TT) Decomposition Using GPU Tensor Cores

In accordance with some embodiments, the above-described tensor-train primitives can be used to implement tensor-train tensor decompositions using GPU tensor cores.

More particularly, in some embodiments, a shard mode using the above-described tensor-train primitives can be used to schedule high-order tensor computations on multiple GPUs.

In some embodiments, a TT tensor decomposition can be converted to a d-th order tensor [symbol] ∈ [symbol] ⁿ^{₁}^{×n}^{₂}^{× . . . ×n}^{_{d}} with given TT-ranks (r₀, r₁, . . . , r_{d}) into a TT structure with d third-order tensors [symbol] ₁∈ [symbol] ^{r}^{₀}^{×n}^{₁}^{×r}^{₁}, [symbol] ₂∈ [symbol] ^{r}^{₁}^{×n}^{₂}^{×r}^{₂}, . . . , [symbol] _{d}∈ [symbol] ^{r}^{_{d-1}}^{×n}^{_{d}}^{×r}^{_{d}} as follows:
1. Transfer [symbol] from CPU memory to GPU memory and obtain A₀∈ [symbol] ⁿ^{₁}^{×n}^{₂}^{× . . . ×n}^{_{d}} from [symbol] using efficient memory access as described above.
2. Compute a fat-and-tall matrix multiplication

$$C = {A}_{0} A {}_{0}^{T}$$

using a fat-and-tall matrix multiplication as described above.
3. Perform Eigenvalue decomposition of C to obtain eigen vectors D.
4. Reverse the order of the column vectors of D to obtain G₁∈ [symbol] ^{r}^{₀}ⁿ^{₁}^{×r}^{_{d}}, where G₁(:,i)=D(:,r₀n₁−i), i=1, . . . , r₁.
5. Compute a small-and-fat matrix multiplication

$${A}_{1} = G {}_{1}^{T} {A}_{0}$$

using a small-and-fat matrix multiplication as described above.
6. Obtain [symbol] ₁∈ [symbol] ^{r}^{₀}ⁿ^{₁}^{×r}^{₁} from G₁ using efficient memory access as described above.
7. Repeat lines 4-6 and take Aᵢ as the input of the next loop.
8. Obtain [symbol] _{d}∈ [symbol] ^{r}^{_{d-1}}^{×n}^{_{d}}^{×r}^{_{d}} from A_{d-1} using efficient memory access as described above.

### High-Order Tensor-Ring (TR) Tensor Decomposition

In accordance with some embodiments, high-order TR tensor decomposition can be implemented similarly to the high-order TT tensor decomposition. At the first loop, there are three differences. First, Reverse the order of the column vectors of D to obtain G₁∈ [symbol] ⁿ^{₁}^{×r}^{₁}^{r}^{₀}, where G₁(:,i)=D(:,n₁−i), i=1, . . . , r₀r₁. Second, obtain [symbol] ₁∈ [symbol] ^{r}^{₀}^{×n}^{₁}^{×r}^{₁} from G₁,

$${𝒢}_{1} ( i , k \% {r}_{0} , ⌊ \frac{j}{{r}_{0}} ⌋ ) = {G}_{1} ( i , j ) , \qquad ( 2 )$$

where i=1, . . . , n₁ and j=1, . . . , r₀r₁. Third, obtain A₁∈ [symbol] ^{r}^{₁}ⁿ^{₂}^{×n}^{₃} ^{. . . n}^{_{d}}^{r}^{₀} from E,

$${A}_{1} ( ⌊ \frac{j}{{r}_{0}} ⌋ , ( j \% {r}_{0} ) i ) = E ( i , j ) , \qquad ( 3 )$$

where i=1, . . . , r₀r₁ and j=1, . . . , n₂n₃ . . . n_{d}.

### High Order Tensor-Train Decomposition Using GPU Tensor Cores

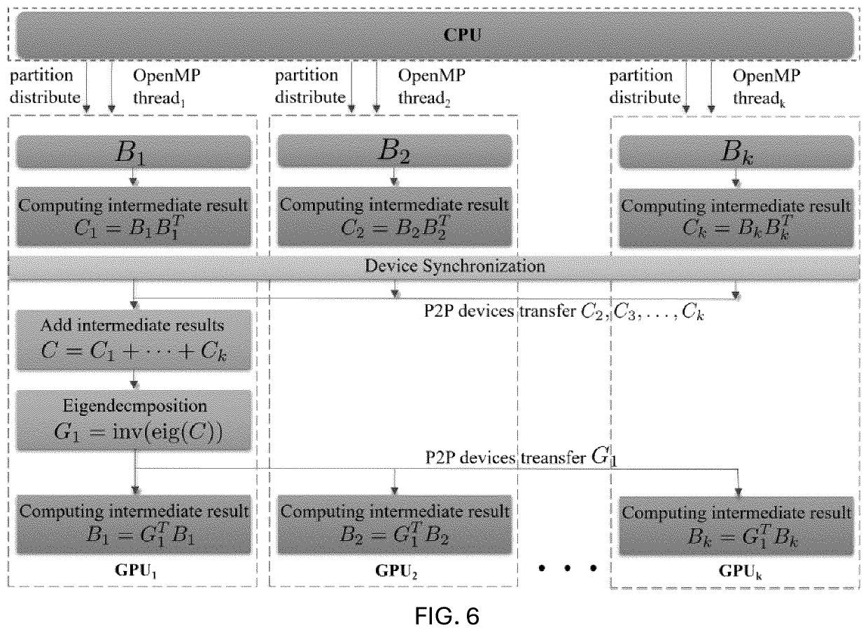

In some embodiments, in high-order TT tensor decompositions, the most time-consuming computations are data transfer and matrix multiplications. In step 1 above, in some embodiments, the input tensor [symbol] ∈ [symbol] ⁿ^{₁}^{×n}^{₂}^{× . . . ×n}^{_{d}} takes the major part of GPU memory consumption, and the transfer of tensor [symbol] takes a large fraction of the execution time. In order to process high-order tensors, in some embodiments, a shard mode that executes on multiple GPUs, as shown in FIG. 6, can be used.

In accordance with some embodiments, high-order TT tensor decomposition using shard mode on k GPUs can be performed as follows:
1. Store tensor [symbol] ∈ [symbol] ⁿ^{₁}^{×n}^{₂}^{× . . . ×n}^{_{d}} as a vector a∈ [symbol] ⁿ^{₁}ⁿ^{₂} ^{. . . n}^{_{d}} in a column-major format in CPU memory.
2. As shown in FIG. 6, transfer

$$a ( ( i - 1 ) {n}_{1} \frac{{n}_{2} {n}_{3} … {n}_{d}}{k} + 1 , {in}_{1} \frac{{n}_{2} {n}_{3} … {n}_{d}}{k} )$$

from CPU memory to GPUᵢ memory as Bᵢ∈

$${ℝ}^{{n}_{1} \times \frac{{n}_{2} {n}_{3} … {n}_{d}}{k}}$$

in parallel, where i=1, . . . , k.
3. Compute

$${C}_{i} = {B}_{i} {B}_{i}^{T}$$

in parallel GPUᵢ using a batched fat-and-tall matrix multiplication as described above.
4. Transfer Cᵢ to GPU₁ memory (e.g., using an NVLink P2P transmission) and add C₁, C₂, . . . , Cₖ to obtain C∈ [symbol] ⁿ^{₁}^{×n}^{₁}.
5. In GPU₁, perform Eigenvalue decomposition of C to obtain eigen vectors D∈ [symbol] ⁿ^{₁}^{×n}^{₁} and obtain G₁∈ [symbol] ⁿ^{₁}^{×r}^{₁} from D, where G₁(:,i)=D(:,n₁−i+1), i=1, . . . , r₁. Fold G₁ to [symbol] ₁∈ [symbol] ^{r}^{₀}^{×n}^{₁}^{×n}^{₁}.
6. Transfer G₁ to GPUᵢ memory (e.g., using an NVLink P2P transmission) and compute

$${B}_{i} = G {}_{1}^{T} {B}_{i}$$

in parallel using a batched small-and-fat matrix multiplication as described above. Take Bᵢ as the input of the next loop.
7. Repeat steps 3-6 above to obtain [symbol] ₂∈ [symbol] ^{r}^{₁}^{×n}^{₂}^{×r}^{₂}, [symbol] ₃∈ [symbol] ^{r}^{₂}^{×n}^{₃}^{×r}^{₃}, . . . , [symbol] _{d-1}∈ [symbol] ^{r}^{_{d-2}}^{×n}^{_{d-1}}^{×r}^{_{d-1}}.
8. Combine B₁ . . . . B_{d} to B and fold B to [symbol] _{d}∈ [symbol] ^{r}^{_{d-1}}^{×n}^{_{d}}^{×r}^{_{d}}.

In accordance with some embodiments, the execution of high-order TR tensor decompositions using shard mode can be implemented similarly to high-order TT tensor decompositions using shard mode. In step 4 of the first loop, transfer Bᵢ to GPU₁ memory (e.g., using an NVLink P2P transmission) and obtain E=(B₁:B₂: . . . :Bₖ)∈ [symbol] ^{r}^{₀}^{r}^{₁}^{×n}^{₂} ^{. . . n}^{_{d}}. Obtain A₁∈ [symbol] ^{r}^{₁}ⁿ^{₂}^{×n}^{₃} ^{. . . n}^{_{d}}^{r}^{₀} from E according to equation (3) and transfer

$${A}_{1} ( 1 : {r}_{1} {n}_{2} , ( i - 1 ) \frac{{n}_{3} … {n}_{d} {r}_{0}}{k} + 1 : i \frac{{n}_{3} … {n}_{d} {r}_{0}}{k} )$$

to GPUᵢ memory as

$${B}_{i} ∈ {ℝ}^{{r}_{1} {n}_{2} \times \frac{{n}_{3} … {n}_{d} {r}_{0}}{k}} .$$

in parallel, where i=2, . . . , k.

In some embodiments, the above-described shard mode is implemented with k threads, which enables the CPU memory to be loaded in parallel at steps 2, thereby reducing the overhead of CPU-GPU communications.

### High-Performance Tensor-Train Tensor Layer for Neural Networks

In accordance with some embodiments, tensor-train tensor layers for deep neural networks can be trained using the above-described tensor-train primitives.

A fully connected layer of a deep neural network (DNN) applies a linear transformation to input vector x∈ [symbol] ^{N}:

$$y = σ ( W x + c ) , \qquad ( 4 )$$

where σ(·) is an activation function, W∈ [symbol] ^{M×N} is the weight matrix, c∈ [symbol] ^{M} is the bias vector and y∈ [symbol] ^{M} is the output vector.

To implement a tensor-train tensor layer to replace a fully connected layer of a DNN, equation (4) can be changed to tensor format, in accordance with some embodiments. For example, y, W, X, c can be changed to [symbol] ∈ [symbol] ^{m}^{₁}^{×m}^{₂}^{×m}^{₃}, [symbol] ∈ [symbol] ^{m}^{₁}ⁿ^{₁}^{×m}^{₂}ⁿ^{₂}^{×m}^{₃}ⁿ^{₃}, [symbol] ∈ [symbol] ⁿ^{₁}^{×n}^{₂}^{×n}^{₃}, [symbol] ^{m}^{₁}^{×m}^{₂}^{×m}^{₃}, respectively, where

$$M = {\prod }_{i = 1}^{3} {m}_{i} and N = {\prod }_{i = 1}^{3} {n}_{i} ,$$

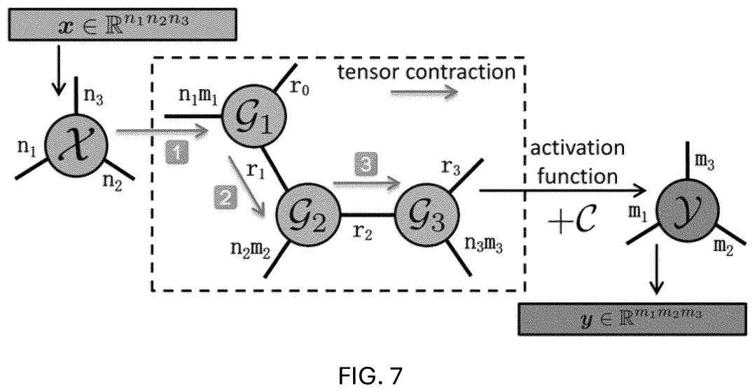

in some embodiments. After decomposing the weight tensor [symbol] into tensor-train format in equation (1) with TT-ranks (r₀, r₁, r₂, r₃) with r₀=r₃=1, the fully connected layer of equation (4) can be expressed as:

$$𝒴 = σ ( {𝒢}_{3} ∘ ( {𝒢}_{2} ∘ ( {q}_{1} ∘ 𝒳 ) ) + 𝒞 ) , \qquad ( 5 )$$

where [symbol] ₁∈ [symbol] ^{r}^{₀}^{×m}^{₁}ⁿ^{₁}^{×r}^{₁}, [symbol] ₂∈^{r}^{₁}^{×m}^{₂}ⁿ^{₂}^{×r}^{₃}, [symbol] ₃∈ [symbol] ^{r}^{₂}^{×m}^{₃}ⁿ^{₃}^{×r}^{₃} are the weight tensors of linear-sub-layers, as shown in FIG. 7, in some embodiments. In some embodiments, the number of parameters can be reduced from m₁n₁m₂n₂m₃n₃ to (r₀m₁n₁r₁+r₁m₂n₂r₂+r₂m₃n₃r₃).

In some embodiments, the natural gradient can be used to optimize the parameters of tensor-train tensor layers, θ={ [symbol] ₁, [symbol] ₂, [symbol] ₃, [symbol] }. In some embodiments, the natural gradient estimates the gradients as:

$${∇}_{θ} F ( θ ) \approx \frac{1}{σ N} {\sum }_{i = 1}^{N} Loss ( θ + {ϵ}_{i} ) {ϵ}_{i} , \qquad ( 6 )$$

where we denote Loss(·) as the loss function, ϵᵢ˜ [symbol] (0, σ²I) as the perturbation, i=1, 2, . . . , N, and σ² as the standard deviation. The parameters of N offspring are generated by adding ϵᵢ to θ, in some embodiments.

### Training Process of Tensor-Train Tensor Layer

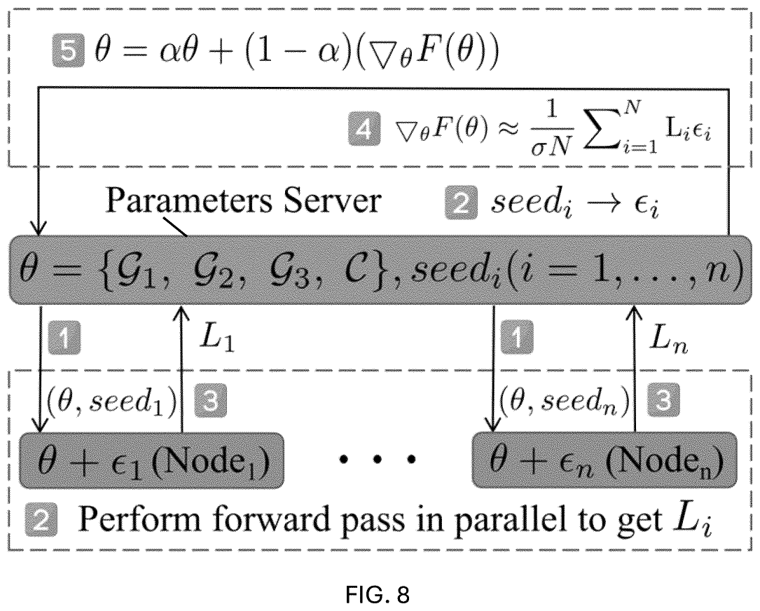

In accordance with some embodiments, FIG. 8 illustrates an example of a process for updating a tensor-train tensor layer during training. In some embodiments, in each training epoch for a tensor-train tensor layer, the steps for updating the layer can be implemented as follows:
0. In the parameters server, Gaussian seedᵢ is randomly generated.
1. In step [1] shown in FIG. 8, nodeᵢ gets θ and seedᵢ from the parameters server and generates Gaussian random noise ϵᵢ˜ [symbol] (0, σ²I), where σ² is standard deviation and each ϵᵢ has the same size as θ.
2. In step [2] shown in FIG. 8, nodeᵢ performs a forward pass with parameters θ+ϵᵢ using the tensor contraction technique described above and gets the loss Lᵢ=Loss(θ+ϵᵢ). N=1 . . . n nodes execute the N forward passes in parallel. Meanwhile, the parameters server generates Gaussian pseudo-random noise ϵᵢ according to seedᵢ.
3. In step [3] shown in FIG. 8, the parameters server gets the L; from nodeᵢ.
4. In step [4] shown in FIG. 8, equation (6) is used to estimate the natural gradient ∇_{θ}F(θ).
5. In step [5] shown in FIG. 8, θ is update to be equal to αθ+(1−α)(∇_{θ}F(θ)), where α is the learning rate.

As shown in the figure, in some embodiments, to reduce the data exchange, seedᵢ is transferred from the parameters server to the n nodes instead of transferring ϵᵢ, which reduces the overhead from O(r₀m₁n₁r₁+r₁m₂n₂r₂+r₂m₃n₃r₃) to O(1).

In some embodiments, in all nodes, forward passes can be executed simultaneously with tensor contraction as described above.

### DMRG Algorithm

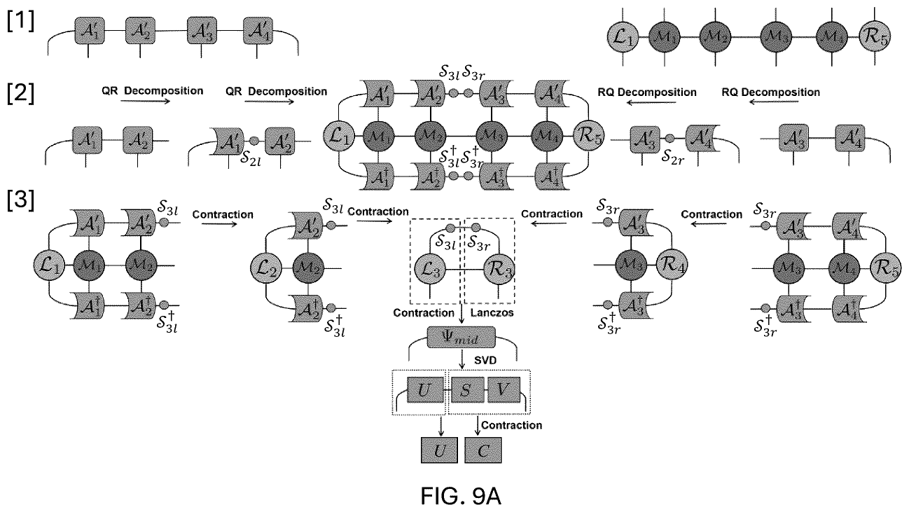

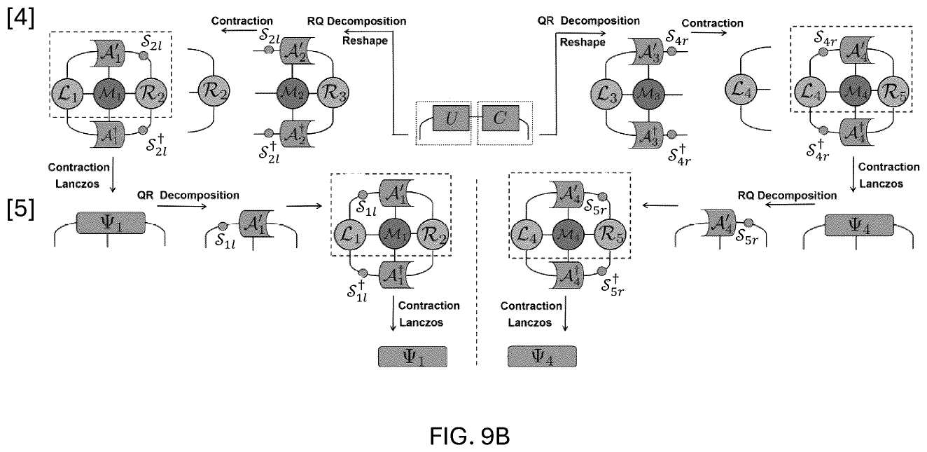

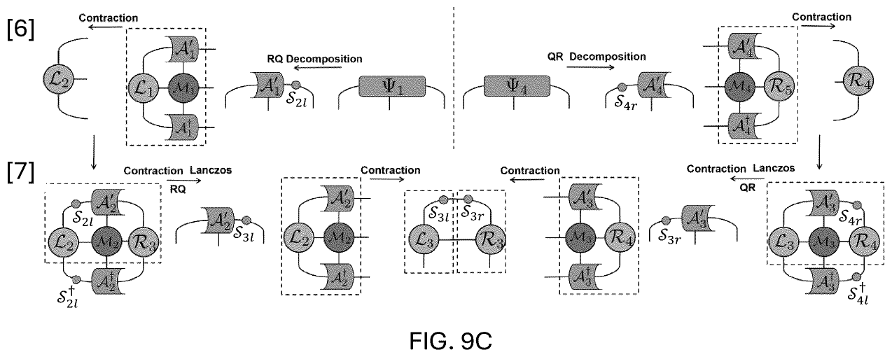

In accordance with some embodiments, in quantum machine learning, a parallel Density Matrix Renormalization Group (DMRG) algorithm can be configured to learn a tensor train structure as illustrated in FIG. 9.

In some embodiments, the parallel DMRG algorithm gets the ground state energy of the physical system and can be understood as minimizing the following problem:

$$E = {min}_{〈 {φ}_{i} \vert {φ}_{i} 〉 = 1} 〈 {φ}_{i} \vert \hat{H} \vert {φ}_{i} 〉 , \qquad ( 7 )$$

where the Hamiltonian quantity

$$\hat{H} = 2 {K}_{p} {K}_{p} + 2 {K}_{m} {K}_{m} , {K}_{p} = [ \begin{matrix}0 & 0 \\ 1 & 0\end{matrix} ] , {K}_{m} = [ \begin{matrix}0 & 1 \\ 0 & 0\end{matrix} ]$$

under the study of the quantum Ising model, and φᵢ is a single site in system, where i=1, . . . , n. In some embodiments, inputs of the DMRG are the primitive states of sites φᵢ in Matrix Product State (MPS) format

$${𝒜}_{i}^{′}$$

and the Hamiltonian quantity Ĥ in Matrix Product Operator (MPO) format [symbol] ᵢ,

$${ℒ}_{1} = [ 1 ] ∈ {ℝ}^{1 \times 1 \times 1} and {ℛ}_{5} = [ 1 ] ∈ {ℝ}^{1 \times 1 \times 1} ,$$

$$where {ℳ}_{i} = [ \begin{matrix}1 & 0 & 0 & 0 \\ \sqrt{2} {K}_{p} & 0 & 0 & 0 \\ \sqrt{2} {K}_{m} & 0 & 0 & 0 \\ 0 & \sqrt{2} {K}_{m} & \sqrt{2} {K}_{p} & 1\end{matrix} ] , I = [ \begin{matrix}1 & 0 \\ 0 & 1\end{matrix} ] .$$

The output is the lowest state energy of the system, in some embodiments.

A Lanczos decomposition aims to obtain the minimum eigenvalue e and eigen vectors Ψ of a tensor [symbol] :

$$[ e , Ψ ] = Lanczos ( ℬ ) . \qquad ( 8 )$$

In accordance with some embodiments, an example parallel single-site finite DMRG algorithm with n=4 sites is shown in FIG. 9. In some embodiments, the main operation of the parallel DMRG algorithm is tensor contraction, which can be performed as described herein and which can be greatly accelerated on GPU tensor cores. In some embodiments, the tensor contractions can be batched onto GPU tensor cores as shown above and the left and right parts of the parallel DMRG algorithm can be performed in parallel.

### Implementation of Parallel DMRG

In accordance with some embodiments, a parallel DMRG algorithm can be implemented as follows:
1. In Step [1] shown in FIG. 9A,

$${𝒜}_{1}^{′} , {𝒜}_{2}^{′} , {𝒜}_{3}^{′} , {𝒜}_{4}^{′}$$

are initialized in MPS format and [symbol] ₁, [symbol] ₂, [symbol] ₃, [symbol] ₄, [symbol] ₁, [symbol] ₅ are initialized in MPO format.
2. In Step [2] shown in FIG. 9A, the left and right parts are regularized in parallel.
3. In Step [3] shown in FIG. 9A, tensor contraction is performed in parallel using the tensor contraction technique described above to obtain [symbol] ₂, [symbol] ₄ and then [symbol] ₃, [symbol] ₃, contraction Lanczos is performed to obtain Ψ_{mid}, the rSVD described above is performed on Ψ_{mid}, and the tensor contraction technique described above is performed on the rSVD's result to obtain U and C. The matrices S and V are not used directly, rather the matrix C=SV^{T} is used instead, in accordance with some embodiments.
4. In Step [4] shown in FIG. 9B, RQ and QR decompositions of U and C are performed in parallel to obtain

$${𝒜}_{2}^{′} , {𝒮}_{2 l} and {𝒜}_{3}^{′} , {𝒮}_{4 r} ,$$

respectively, and tensor contraction using the tensor contraction technique described above is performed in parallel to obtain [symbol] ₂ and [symbol] ₄.
5. In Step [5] shown in FIG. 9B, tensor contraction using the tensor contraction technique described above is performed in parallel to obtain Ψ₁, Ψ₄, QR and RQ decompositions are performed in parallel to obtain

$${𝒜}_{1}^{′} , {𝒮}_{1 l} and {𝒜}_{4}^{′} , {𝒮}_{5 r} ,$$

respectively, and tensor contraction is performed in parallel using the tensor contraction technique described above to obtain Ψ₁, Ψ₄, and.
6. In Step [6], RQ and QR decompositions are performed in parallel to obtain [symbol] _{1′}, [symbol] ₂ₗ and [symbol] _{4′}, [symbol] ₄ᵣ, and tensor contraction using tensor contraction as described above is performed in parallel to obtain [symbol] ₂ and [symbol] ₄.
7. In Step [7], tensor contraction using the tensor contraction describe above is performed, and RQ and QR decompositions are performed in parallel to obtain

$${𝒜}_{2}^{′} , {𝒮}_{3 l} and {𝒜}_{3}^{′} , {𝒮}_{3 r} ,$$

respectively, and tensor contraction using the tensor contraction described above is performed in parallel to obtain [symbol] ₃ and [symbol] ₃.
8. Perform step 7 until converge when the system energy is less than a threshold or meets the maximum sweep.

The mechanisms described herein can be implemented in any suitable computing devices. For example, in some embodiments, the mechanisms described herein can be implemented using any suitable general-purpose computer or special-purpose computer(s). Any such general-purpose computer or special-purpose computer can include any suitable hardware.

In some embodiments, the mechanisms described herein can be implemented in a DGX-2 server that has 2 TB DDR4 memory, two AMD EPYC 7742 CPUs, and eight NVIDIA A100 GPUs, where each CPU has 64 physical cores that support 128 threads, each A100 GPU has 40 GB memory, 6912 CUDA cores, and 432 tensor cores, and the server runs Ubuntu Linux 20.04 and CUDA 11.0.

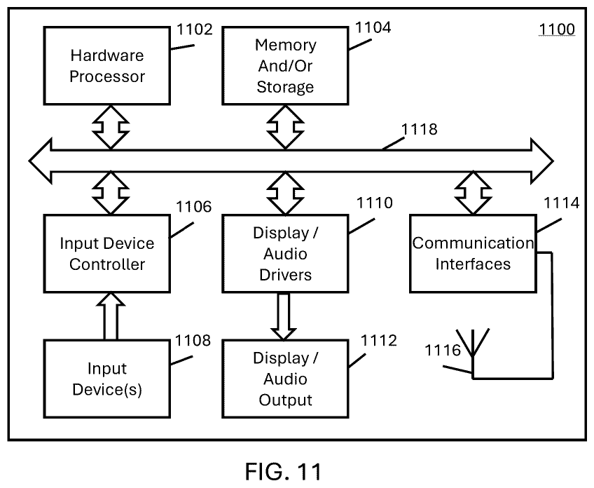

As another example, as illustrated in example hardware 1100 of FIG. 11, such hardware can include hardware processor 1102, memory and/or storage 1104, an input device controller 1106, an input device 1108, display/audio drivers 1110, display and audio output circuitry 1112, communication interface(s) 1114, an antenna 1116, and a bus 1118.

Hardware processor 1102 can include any suitable hardware processor, such as a graphical processing unit (GPU), a tensor processing unit (TPU), a microprocessor, a micro-controller, digital signal processor(s), dedicated logic, and/or any other suitable circuitry for controlling the functioning of a general-purpose computer or a special purpose computer in some embodiments.

Memory and/or storage 1104 can be any suitable memory and/or storage for storing programs, data, and/or any other suitable information in some embodiments. For example, memory and/or storage 1104 can include random access memory, read-only memory, flash memory, hard disk storage, optical media, and/or any other suitable memory.

Input device controller 1106 can be any suitable circuitry for controlling and receiving input from input device(s) 1108, in some embodiments. For example, input device controller 1106 can be circuitry for receiving input from an input device 1108, such as a touch screen, from one or more buttons, from a voice recognition circuit, from a microphone, from a camera, from an optical sensor, from an accelerometer, from a temperature sensor, from a near field sensor, an automobile navigation system, from a global positioning system, and/or any other type of input device.

Display/audio drivers 1110 can be any suitable circuitry for controlling and driving output to one or more display/audio output circuitries 1112 in some embodiments. For example, display/audio drivers 1110 can be circuitry for driving one or more display/audio output circuitries 1112, such as an LCD display, a speaker, an LED, or any other type of output device.

Communication interface(s) 1114 can be any suitable circuitry for interfacing with one or more communication networks. For example, interface(s) 1114 can include network interface card circuitry, wireless communication circuitry, and/or any other suitable type of communication network circuitry.

Antenna 1116 can be any suitable one or more antennas for wirelessly communicating with a communication network in some embodiments. In some embodiments, antenna 1116 can be omitted when not needed.

Bus 1118 can be any suitable mechanism for communicating between two or more components 1102, 1104, 1106, 1110, and 1114 in some embodiments.

Any other suitable components can additionally or alternatively be included in hardware 1100 in accordance with some embodiments.

It should be understood that at least some of the above-described operations of the algorithms, processes, and methods can be executed or performed in any order or sequence not limited to the order and sequence described above. Also, some of the above operations of the algorithms, processes, and methods can be executed or performed substantially simultaneously where appropriate or in parallel to reduce latency and processing times. Additionally or alternatively, some of the above-described operations of the algorithms, processes, and methods can be omitted.

In some embodiments, any suitable computer readable media can be used for storing instructions for performing the functions and/or processes described herein. For example, in some embodiments, computer readable media can be transitory or non-transitory. For example, non-transitory computer readable media can include media such as non-transitory magnetic media (such as hard disks, floppy disks, and/or any other suitable magnetic media), non-transitory optical media (such as compact discs, digital video discs, Blu-ray discs, and/or any other suitable optical media), non-transitory semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable non-transitory tangible media. As another example, transitory computer readable media can include signals on networks, in wires, conductors, optical fibers, circuits, any suitable media that is fleeting and devoid of any semblance of permanence during transmission, and/or any suitable intangible media.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for implementing tensor-trains, comprising:
a memory;
at least one hardware processor collectively configured to perform at least one of:
(A.1) partitioning a first matrix into a first plurality of blocks along a column dimension and partitioning a second matrix into a second plurality of blocks along a row dimension; and
(B.1) partitioning a third matrix into a third plurality of blocks along a column dimension;
and
a first graphics processing unit (GPU) tensor core configured to perform at least one of:
(A.2) loading a first block of the first plurality of blocks and a second block of the second plurality of blocks into the first GPU tensor core; and
(A.3) performing a multiplication of the first block and the second block to produce a first product;
and
(B.2) loading a fourth matrix and a fifth block of the third plurality of blocks into a third graphics processing unit tensor core; and
(B.3) performing a multiplication of the fourth matrix and the fifth block to produce a third product;
a second GPU tensor core configured to:
(A.4) load a third block of the first plurality of blocks and a fourth block of the second plurality of blocks into the second GPU tensor core;
(A.5) perform a multiplication of the third block and the fourth block to produce a second product; and
(A.6) summing at least the first product and the second product to produce a first sum.

2. The system of claim 1, wherein the at least one of the hardware processor also performs at least one of:
prior to partitioning the first matrix and the second matrix, reducing a precision of the first matrix and the second matrix; and
prior to partitioning the third matrix, reducing a precision of the third matrix and the fourth matrix.

3. The system of claim 1, wherein the first GPU tensor core also:
performs a QR factorization of the first sum to produce a first orthogonal matrix;
performs a multiplication of the first orthogonal matrix and a transposition of the first orthogonal matrix to produce a fourth product;
performs an eigenvalue decomposition of the fourth product to obtain first eigenvectors;
reverse the order of the first eigenvectors to produce second eigenvectors;
performs a multiplication of the first orthogonal matrix and the second eigenvectors to produce a fifth product;
performs a multiplication of a transposition of the second eigenvectors and the first orthogonal matrix to produce a sixth product; and
folds the fifth product and the sixth product.

4. The system of claim 1, wherein:
the at least one hardware processor also matricizes a first tensor to produce the first matrix and transfers the first matrix to the first GPU tensor core; and
the first GPU tensor core, at least partially concurrently with the transferring of the first matrix to the first GPU tensor core, generates the second matrix.

5. The system of claim 1, wherein the first GPU tensor core also trains a tensor-train tensor layer of a neural network.

6. The system of claim 1, wherein the first GPU tensor core also performs a parallel Density Matrix Renormalization Group (DMRG) algorithm.

7. A method of implementing tensor-trains, comprising:
performing at least one of:
partitioning a first matrix into a first plurality of blocks along a column dimension and partitioning a second matrix into a second plurality of blocks along a row dimension;
loading a first block of the first plurality of blocks and a second block of the second plurality of blocks into a first graphics processing unit (GPU) tensor core;
performing a multiplication of the first block and the second block to produce a first product;
loading a third block of the first plurality of blocks and a fourth block of the second plurality of blocks into a second GPU tensor core;
performing a multiplication of the third block and the fourth block to produce a second product; and
summing at least the first product and the second product to produce a first sum;
and
partitioning a third matrix into a third plurality of blocks along a column dimension;
loading a fourth matrix and a fifth block of the third plurality of blocks into a third graphics processing unit tensor core; and
performing a multiplication of the fourth matrix and the fifth block to produce a third product.

8. The method of claim 7, further comprising at least one of:
prior to partitioning the first matrix and the second matrix, reducing a precision of the first matrix and the second matrix; and
prior to partitioning the third matrix, reducing a precision of the third matrix and the fourth matrix.

9. The method of claim 7, further comprising:
performing a QR factorization of the first sum to produce a first orthogonal matrix;
performing a multiplication of the first orthogonal matrix and a transposition of the first orthogonal matrix to produce a fourth product;
performing an eigenvalue decomposition of the fourth product to obtain first eigenvectors;
reversing the order of the first eigenvectors to produce second eigenvectors;
performing a multiplication of the first orthogonal matrix and the second eigenvectors to produce a fifth product;
performing a multiplication of a transposition of the second eigenvectors and the first orthogonal matrix to produce a sixth product; and
folding the fifth product and the sixth product.

10. The method of claim 7, further comprising:
matricizing a first tensor to produce the first matrix; and
at least partially concurrently, transferring the first matrix to the first GPU tensor core and generating the second matrix.

11. The method of claim 7, further comprising training a tensor-train tensor layer of a neural network.

12. The method of claim 7, further comprising performing a parallel Density Matrix Renormalization Group (DMRG) algorithm.

13. A non-transitory computer-readable medium containing computer executable instructions that, when collectively executed by at least one processor, a first graphics processing unit (GPU) tensor core, and a second GPU tensor core, cause the at least one processor, the first GPU tensor core, and the second GPU tensor core to collectively perform a method of implementing tensor-trains, the method comprising:
partitioning a first matrix into a first plurality of blocks along a column dimension and partitioning a second matrix into a second plurality of blocks along a row dimension;
loading a first block of the first plurality of blocks and a second block of the second plurality of blocks into a first GPU tensor core;
performing a multiplication of the first block and the second block to produce a first product;
loading a third block of the first plurality of blocks and a fourth block of the second plurality of blocks into a second GPU tensor core;
performing a multiplication of the third block and the fourth block to produce a second product; and
summing at least the first product and the second product to produce a first sum;
partitioning a third matrix into a third plurality of blocks along a column dimension;
loading a fourth matrix and a fifth block of the third plurality of blocks into a third graphics processing unit tensor core; and
performing a multiplication of the fourth matrix and the fifth block to produce a third product.

14. The non-transitory computer-readable medium of claim 13, wherein the method further comprises at least one of:
prior to partitioning the first matrix and the second matrix, reducing a precision of the first matrix and the second matrix; and
prior to partitioning the third matrix, reducing a precision of the third matrix and the fourth matrix.

15. The non-transitory computer-readable medium of claim 13, wherein the method further comprises:
performing a QR factorization of the first sum to produce a first orthogonal matrix;
performing a multiplication of the first orthogonal matrix and a transposition of the first orthogonal matrix to produce a fourth product;
performing an eigenvalue decomposition of the fourth product to obtain first eigenvectors;
reversing the order of the first eigenvectors to produce second eigenvectors;
performing a multiplication of the first orthogonal matrix and the second eigenvectors to produce a fifth product;
performing a multiplication of a transposition of the second eigenvectors and the first orthogonal matrix to produce a sixth product; and
folding the fifth product and the sixth product.

16. The non-transitory computer-readable medium of claim 13, wherein the method further comprises:
matricizing a first tensor to produce the first matrix; and
at least partially concurrently, transferring the first matrix to the first GPU tensor core and generating the second matrix.

17. The non-transitory computer-readable medium of claim 13, wherein the method further comprises training a tensor-train tensor layer of a neural network.

18. The non-transitory computer-readable medium of claim 13, wherein the method further comprises performing a parallel Density Matrix Renormalization Group (DMRG) algorithm.
